(19) United States
(12) Patent Application Publication
(10) Pub. No.: US 2024/0206444 A1
(43) Pub. Date: Jun. 27, 2024

(54) AQUATIC SPECIMEN CAPTURE DEVICE

(71) Applicant: Stephen Vernaglia, Delray Beach, FL (US)

(72) Inventor: Stephen Vernaglia, Delray Beach, FL (US)

(21) Appl. No.: 18/241,438

(22) Filed: Sep. 1, 2023

Related U.S. Application Data
(60) Provisional application No. 63/403,439, filed on Sep. 2, 2022.

(51) Int. Cl. A01K 69/04

(52) U.S. Cl. CPC A01K 69/04

(57) ABSTRACT

An aquatic specimen capture device may include a collapsible elongated container, a top and bottom rim lid attached to the collapsible elongated container, wherein a bottom rim lid further includes a fastener to attach the collapsible elongated container to another collapsible elongated container.

### CROSS-REFERENCE TO RELATED APPLICATIONS

This application claims the benefit of U.S. Provisional Application No. 63/403,439 filed Sep. 2, 2022.

### TECHNICAL FIELD

The present disclosure is related to an aquatic specimen capture devices and methods of operating the same.

### BACKGROUND OF THE DISCLOSURE

Various marine containment devices are widely used to capture venomous invasive species such as lionfish. The traditional marine containment devices are tubular and designed to hold a single species at a time, thus limiting the number of species divers can capture in one go. To harvest multiple marine species at the same time, divers need to carry larger containment units which may be difficult to secure to the dive gear. Additionally, diving with multiple small marine containment devices may result in losing the device if not secure properly.

### SUMMARY OF THE DISCLOSURE

This summary is provided to introduce a variety of concepts in a simplified form that is disclosed further in the detailed description of the embodiments. This summary is not intended to identify key or essential inventive concepts of the claimed subject matter, nor is it intended to determine the scope of the claimed subject matter.

An aquatic containment device may include a collapsible elongated container with a top end and a bottom end including a plurality of corner sides of the collapsible elongated container.

The aquatic containment device may include a collapsible elongated container that forms a hollow body to receive and hold an aquatic species. The aquatic containment device where the collapse elongated container is a four-piece square shape. The aquatic containment device may include a plurality of mounting clips designed to maintain a safe distance from an aquatic species. The aquatic containment device may include a screen replaceably connected to the bottom rim lid, thereby covering the bottom rim lid to drain without unintended contact with the aquatic species.

The aquatic containment device may include a living hinge along an edge. The aquatic containment device may include a fastener attached to the bottom rim lid having a zip tie lock, an elastic lock, a side extension lock, a clip lock, a pilot lock, or latch.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 is a perspective view illustrating an aquatic specimen capture device in accordance with some embodiments;

FIG. 2 is an exploded perspective view illustrating an aquatic specimen capture device in accordance with some embodiments;

FIG. 3 is a top perspective view illustrating an aquatic specimen capture device in accordance with some embodiments;

FIG. 4 is a back perspective view illustrating an aquatic specimen capture device in accordance with some embodiments;

FIGS. 5a and 5b are side perspective views illustrating an aquatic specimen capture device in accordance with some embodiments;

FIGS. 6a to 6d are perspective views illustrating fasteners of an aquatic specimen capture device in accordance with some embodiments;

FIG. 7 is a perspective view illustrating an aquatic specimen capture device in accordance with some embodiments;

FIG. 8 is a perspective view illustrating a collapsible aquatic specimen capture device in accordance with some embodiments; and

FIG. 9 is a perspective view illustrating a collapsible aquatic specimen capture device in accordance with some embodiments.

The drawings are not necessarily to scale, and certain features and certain views of the drawings may be shown exaggerated in scale or in schematic in the interest of clarity and conciseness.

### DETAILED DESCRIPTION OF THE DISCLOSURE

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

An aquatic containment device may include a collapsible elongated container with a top end and a bottom end including a plurality of corner sides of the collapsible elongated container; a plurality of living hinges mechanically attached to the collapsible elongated container, and running from the top end to the bottom end of the collapsible elongated container. The aquatic containment device may also include a top rim lid removably attached to the top end of the collapsible elongated container, including a handle attached to the top rim lid, a plurality of mount clips attached to the top rim lid, a plurality of top spear clips attached to the top rim lid, and a clasp removably received in the top rim lid using a clasp flex lock and at least one clasp hinge.

The device may include a bottom rim lid removably attached to the bottom end of the collapsible elongated container, including a channel attached to the bottom rim lid designed to receive the collapsible elongated container; a fastener attached to the bottom rim lid and designed to removably attached a second collapsible elongated container; a screen replaceably connected to the bottom rim lid thereby covering the bottom rim lid; a plurality of bottom spear clips mechanically attached to the bottom rim lid; and a screw hole defined by the bottom rim lid.

The device may, in addition, include a top rim lid attached to the top end of the collapsible elongated container using a plurality of mount clips and a plurality of top snare clips. The device may moreover include a clasp constructed and arranged to be placed inside the top end of the collapsible elongated container. The device may also include a plurality of the living hinges mechanically attached to the plurality of the corner sides of the collapsible elongated container.

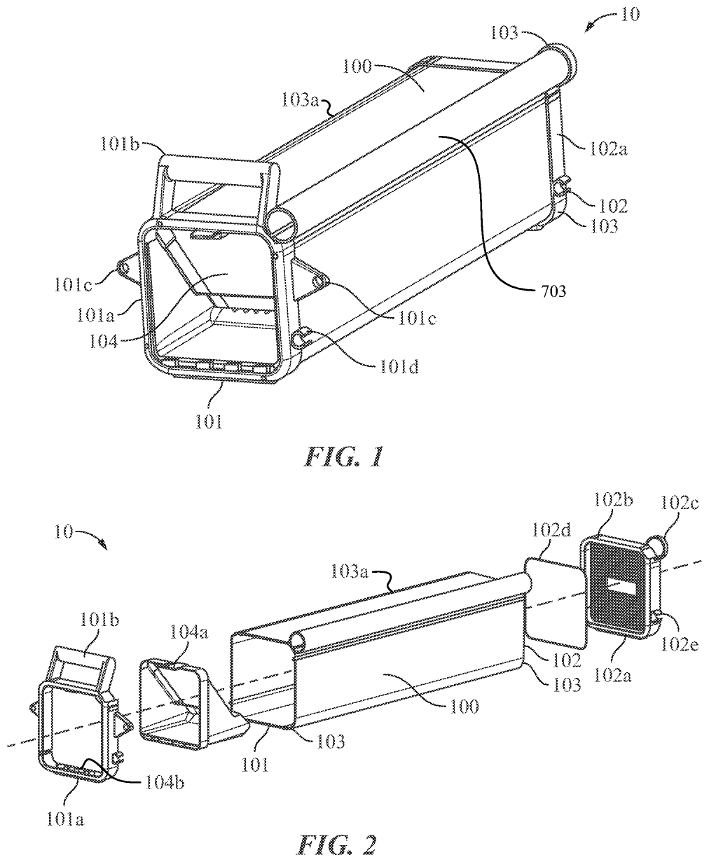

FIGS. 1 and 2 show a perspective view illustrating an aquatic specimen capture device 10 having an elongated collapsible container 100, having a top end 101, a bottom end 102, a plurality of corner sides 103, a plurality of living hinges 103a mechanically attached to the collapsible elongated container and running from top end 101 to the bottom end 102 of the collapsible elongated container 100. The container 100 may be generally rectangular or square, to maximize internal storage in comparison to a cylinder.

The device may also include a top rim lid 101a removably attached to the top end 101 of the collapsible elongated container 100, including a handle 101b attached to the top rim lid 101a, a plurality of mount clips 101c attached to the top rim lid 101a, a plurality of top snare clips 101d attached to the top rim lid 101a, and a entry flap 104 removably received in the top rim lid 101a using a clasp flex lock 104a and at least one clasp hinge 104b.

As illustrated in FIG. 2, device 10 also includes a bottom rim lid 102a removably attached to the bottom end 102 of the collapsible elongated container 100 and further includes a channel 102b attached to the bottom rim lid 102a designed to receive the collapsible elongated container 100 in order to fit inside the bottom rim lid 102a. A fastener 102c is attached to the bottom rim lid 102a and designed to removably attach a second collapsible elongated container (not illustrated) in order to carry two containers together by removably attaching them to each other.

The bottom rim lid 102a further includes a screen 102d replaceably connected to the bottom rim lid 102a, thereby covering the bottom rim lid. A plurality of bottom snare clips 102e are mechanically attached to the bottom rim lid 102a, and a screw hole 102f is defined by the bottom rim lid 102a.

As illustrated in FIGS. 1 and 2 the top rim lid 101a is attached to the top end 101 of the collapsible elongated container 100 using the plurality of top mount clips 101c and the plurality of top snare clips 101d. The clasp 104 is constructed and arranged to be placed inside the top end 101 of the collapsible elongated container 100 and the plurality of the living hinges 103a are mechanically attached to the plurality of the corner sides 103 of the collapsible elongated container 100. The bottom rim lid 102a and top rim lid 101a may be removable from the container 101 and the container 101 may be constructed and arranged to hingedly collapse into a flat-pack configuration.

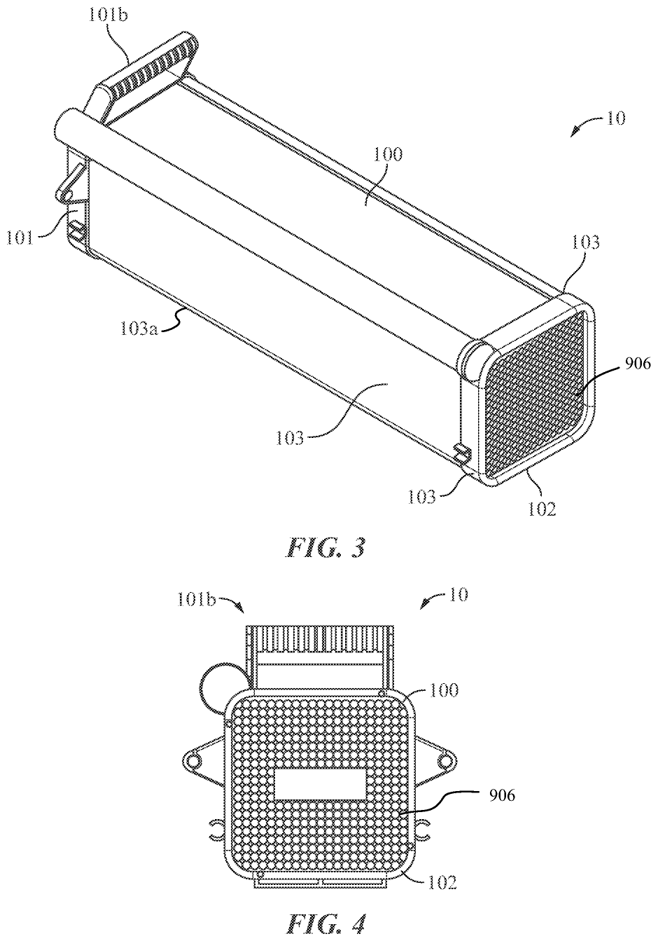

FIG. 3 is a top perspective view illustrating an aquatic specimen capture device 10 having an elongated collapsible container 100, having a top end 101, a bottom end 102, a plurality of corner sides 103, a plurality of living hinges 103a mechanically attached to the collapsible elongated container and running from top end 101 to the bottom end 102 of the collapsible elongated container 100 and showing the plurality of living hinges 103a. The bottom end 102 may include a removable or integrated screen 906 to allow water or fluid to flow into or out of the container 100.

FIG. 4 is a back perspective view illustrating an aquatic specimen capture device 10 showing the bottom rim lid 102a removably attached to the bottom end 102 of the collapsible elongated container 100 and further includes a channel 102b attached to the bottom rim lid 102a designed to receive the collapsible elongated container 100 in order to fit inside the bottom rim lid 102a. A fastener 102c is attached to the bottom rim lid 102a and designed to removably attach a second collapsible elongated container (not illustrated) in order to carry two containers together by removably attaching them to each other. The bottom rim lid 102a further includes a screen 102d replaceable connected to the bottom rim lid 102a, thereby covering the bottom rim lid, and having a screen 906 therein. A plurality of bottom snare clips 102e are mechanically attached to the bottom rim lid 102a, and a screw hole 102f is defined by the bottom rim lid 102a.

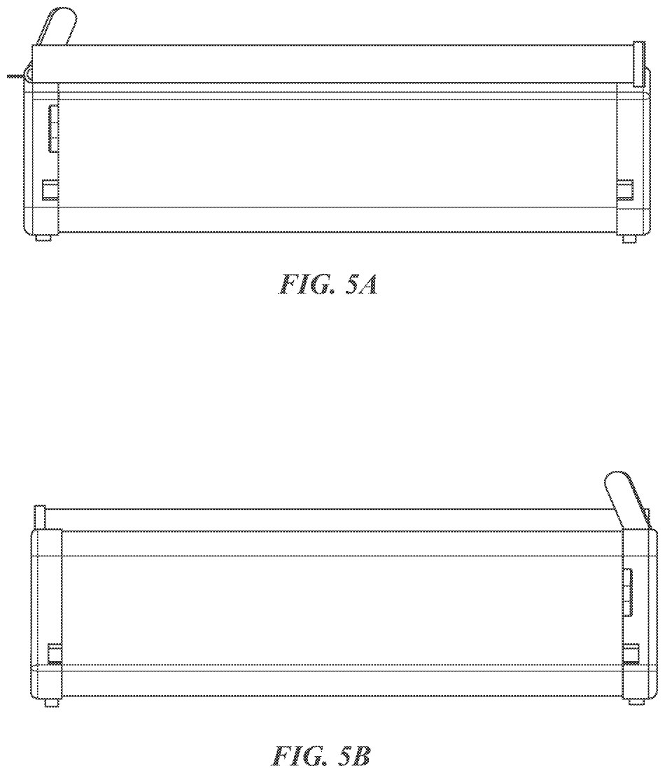

FIGS. 5a and 5b are side perspective views illustrating an aquatic specimen capture device having an elongated container.

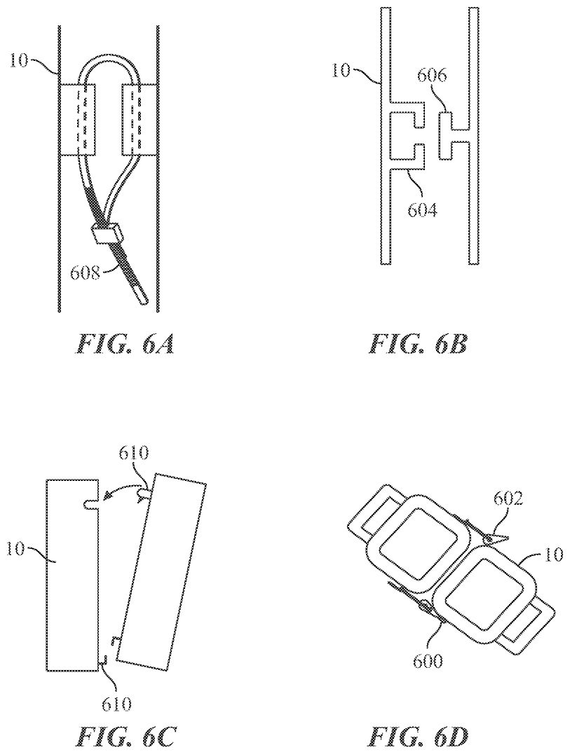

FIGS. 6a to 6d are perspective views illustrating fasteners of an aquatic specimen capture device 10. FIG. 6a-d depicts the fastening of devices 10 to one another via zip ties 608; complimentary mechanical fasteners 604, 606; clip fasteners 610; or elastic cords 600; or latches 602.

The aquatic specimen capture device 10 including a collapsible elongated container 100 may form a hollow body to receive and hold an aquatic species, wherein the collapse elongated container 100 is a four-piece square shape container. The plurality of mounting clips are designed to maintain a safe distance from an aquatic species. The aquatic specimen capture device 10, where the screen 102d is replaceably connected to the bottom rim lid thereby covering the bottom rim lid is designed to drain without unintended contact with the aquatic species.

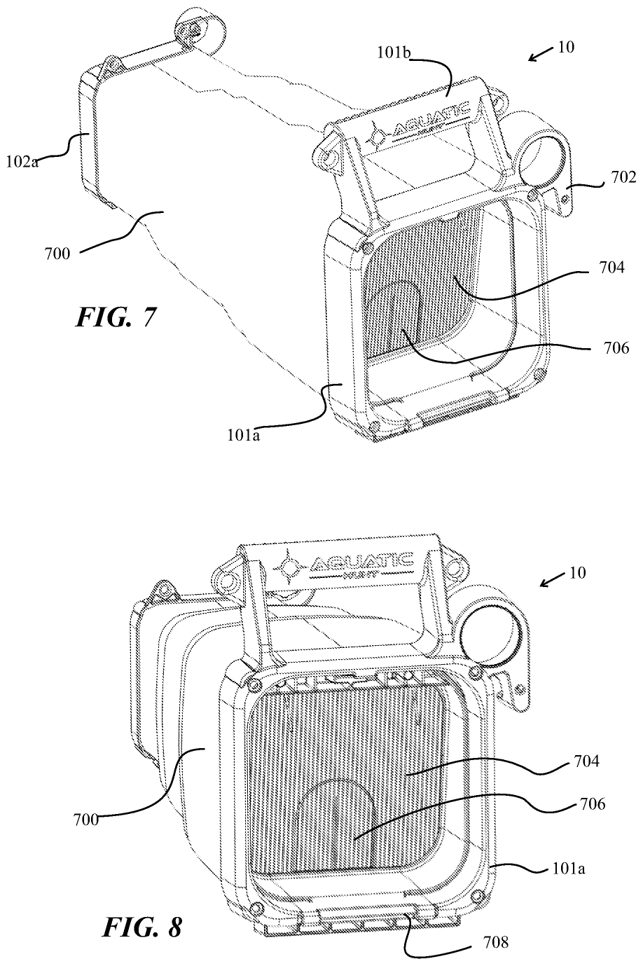

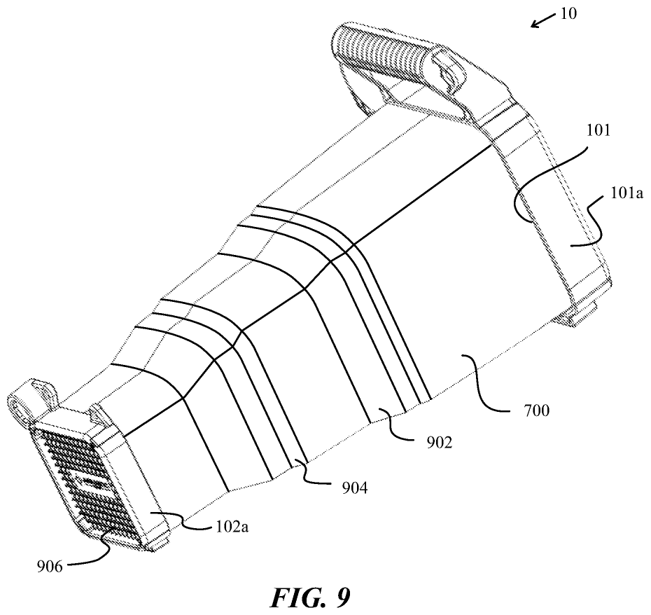

FIGS. 7 and 8 show perspective views illustrating a collapsible aquatic specimen capture device 10 having an elongated collapsible container 700 having a top rim lid 101a opposite a bottom rim lid 102a. The device 10 may include an integrated spear tube 703. The device may include a hook 702 to fasten a spear into the tube using the spear's elastic cord. The device may also include a lid 704 hingedly attached to the top end 101 via a lid hinge 708. The lid hinge 708 may allow for opening of the lid 704 without risking losing a removable lid. According to some embodiments, lid 704 may include a spring-loaded flap or rubber door flap to allow for spear tips of various sizes and shapes to be safely and easily removed from the device. Lid 704 may also include a miniature door 706 that may also include a spring-loaded flap or rubber door flap to allow for spear tips of various sizes and shapes to be safely and easily removed from the device. Referring to FIG. 9, a collapsible aquatic containment device may include a screen 906 replaceably connected to the bottom rim lid 102a. According to some embodiments, the screen may be integrated into the bottom rim lid 102a. The collapsible container 700 may include folding faces 902, 904 constructed and arranged to allow the collapsible container 700 to collapse flat or expand, such as when the container 700 is made of a foldable, flexible material such as thermoplastic polyurethane (TPU). The folding faces 902, 904 may take a variety of forms including bellows or the like. The bottom rim lid 102a may be smaller than the top rim lid 101a such that when container 700 is collapsed, the bottom rim lid 102a is nested within the top rim lid 101a.

The device 10, and the collapsible container in particular, may be constructed by using a corrosion-resistant material such as fabrics, polyolefins-polyethylene and polypropylene (HDPE, LDPE, UHMW, PP), Polyvinyl Chlorides-PVC and CPVC, fluoropolymers (PTFE, FEP, PFA, PVDF, PCTFE, ECTFE, ETFE, etc.), Polycarbonate (PC), Polypropylene (PP), Copolyester (PET, PCTG, PCTA, PETG, PCT), Acrylonitrile Butadiene Styrene (ABS), thermoplastic elastomers (TPE), thermoplastic polyurethane (TPU), and blends or composites of these materials. In particular, the device 10 is constructed of a solid material of construction or other such material to prevent sharp fins, spikes, needles, or lionfish spines, for example, the poisonous spines of a lionfish, from protruding through the bottom end of the device and injuring a diver or other person in the vicinity of the device 10.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, an aquatic specimen capture device may include a collapsible elongated container including a top end opposite a bottom end, a plurality of corner sides of the collapsible elongated container; a top rim lid removably attached to the top end of the collapsible elongated container; and a bottom rim lid removably attached to the bottom end of the collapsible elongated container.

Variation 2 may include an aquatic specimen capture device as in variation 1, wherein the top rim lid is removably attached to the top end of the collapsible elongated container, the collapsible elongated container further including a handle attached to the top rim lid; a plurality of mount clips attached to the top rim lid; a plurality of top spear clips attached to the top rim lid; and a clasp removably received in the top rim lid using a clasp flex lock and at least one clasp hinge.

Variation 3 may include an aquatic specimen capture device as in variation 1 or 2, wherein the bottom rim lid removably attached to the bottom end of the collapsible elongated container, the collapsible elongated container further including a channel attached to the bottom rim lid designed to receive the collapsible elongated container; a fastener attached to the bottom rim lid and designed to removably attached a second collapsible elongated container; a screen replaceably connected to the bottom rim lid thereby covering the bottom rim lid; a plurality of bottom snare clips mechanically attached to the bottom rim lid; and a screw hole defined by the bottom rim lid.

Variation 4 may include an aquatic specimen capture device as in any of variations 1 through 3 wherein the top rim lid is attached to the top end of the collapsible elongated container using a plurality of mount clips and a plurality of top snare clips.

Variation 5 may include an aquatic specimen capture device as in any of variations 1 through 4 wherein a clasp is constructed and arranged to be placed inside the top end of the collapsible elongated container.

Variation 6 may include an aquatic specimen capture device as in any of variations 1 through 5 wherein the plurality of the living hinges are mechanically attached to the plurality of the corner sides of the collapsible elongated container.

Variation 7 may include an aquatic specimen capture device as in any of variations 1 through 6 wherein a fastener attached to the bottom rim lid includes at least one of a zip tie lock, an elastic lock, a side extension lock, a clip lock, a pilot lock, or latch.

Variation 8 may include an aquatic specimen capture device as in any of variations 1 through 7 wherein the collapsible elongated container forms a hollow body to receive and hold an aquatic species.

Variation 9 may include an aquatic specimen capture device as in any of variations 1 through 8 wherein the collapse elongated container is a four-piece square shape.

Variation 10 may include an aquatic specimen capture device as in any of variations 1 through 9 further including a plurality of corner sides are designed to maintain a safe distance from an aquatic species.

Variation 11 may include an aquatic specimen capture device as in any of variations 1 through 10 further including a screen replaceably connected to the bottom rim lid thereby covering the bottom rim lid is designed to drain without unintended contact with the aquatic species.

According to variation 12, a product may include a collapsible container including a top end opposite a bottom end, a plurality of corner sides disposed between the top end and bottom end to define a primary cavity therein; a top rim lid including a handle, the top rim lid being removably attached to the top end of the collapsible container; and a bottom rim lid removably attached to the bottom end of the collapsible container.

Variation 13 may include a product of variation 12, further including a plurality of mount clips attached to the top rim lid; a plurality of top spear clips attached to the top rim lid; and a clasp removably received in the top rim lid using a clasp flex lock and at least one clasp hinge.

Variation 14 may include a product of variation 12 or 13, further including a channel attached to the bottom rim lid designed to receive the collapsible container; a fastener attached to the bottom rim lid designed to removably attach a second collapsible container to the collapsible container; a screen removably connected to the bottom rim lid constructed and arranged to cover the bottom rim lid; a plurality of bottom snare clips mechanically attached to the bottom rim lid; and a screw hole defined by the bottom rim lid.

Variation 15 may include a product as in any of variations 12 through 14, wherein the top rim lid is attached to the top end of the collapsible elongated container using a plurality of mount clips and a plurality of top snare clips.

Variation 16 may include a product as in any of variations 12 through 15, wherein a clasp is constructed and arranged to be placed inside the top end of the collapsible elongated container.

Variation 17 may include a product as in any of variations 12 through 16, wherein the plurality of the living hinges are mechanically attached to the plurality of the corner sides of the collapsible elongated container.

Variation 18 may include a product as in any of variations 12 through 17, wherein the collapsible container, top rim lid, and bottom rim lid include at least one of a polyolefin, polyethylene, polypropylene, polyvinyl chloride, or fluoropolymer.

Variation 19 may include a product as in any of variations 12 through 17, wherein the collapsible container, top rim lid, and bottom rim lid include a corrosion resistant material.

According to variation 20, a corrosion resistant product may include a collapsible container including a top end opposite a bottom end, a plurality of corner sides disposed between the top end and bottom end to define a primary cavity therein; a top rim lid including a handle, the top rim lid being removably attached to the top end of the collapsible container via a plurality of mount clips and a plurality of top snare clips; a bottom rim lid removably attached to the bottom end of the collapsible container, the bottom rim lid defining at least one screw hole therein; a screen replaceably connected to the bottom rim lid thereby covering the bottom rim lid; a channel attached to the bottom rim lid designed to receive the collapsible container; a fastener attached to the bottom rim lid and designed to removably attached a second collapsible container; and a plurality of bottom snare clips mechanically attached to the bottom rim lid.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. An aquatic specimen capture device, comprising:
a collapsible elongated container comprising a top end opposite a bottom end, a plurality of corner sides of the collapsible elongated container;
a top rim lid removably attached to the top end of the collapsible elongated container; and
a bottom rim lid removably attached to the bottom end of the collapsible elongated container.

2. The aquatic specimen capture device of claim 1, wherein the top rim lid is removably attached to the top end of the collapsible elongated container, the collapsible elongated container further comprising:
a handle attached to the top rim lid;
a plurality of mount clips attached to the top rim lid;
a plurality of top spear clips attached to the top rim lid; and
a clasp removably received in the top rim lid using a clasp flex lock and at least one clasp hinge.

3. The aquatic specimen capture device of claim 1, wherein the bottom rim lid removably attached to the bottom end of the collapsible elongated container, the collapsible elongated container further comprising:
a channel attached to the bottom rim lid designed to receive the collapsible elongated container;
a fastener attached to the bottom rim lid and designed to removably attached a second collapsible elongated container;
a screen replaceably connected to the bottom rim lid thereby covering the bottom rim lid;
a plurality of bottom snare clips mechanically attached to the bottom rim lid; and
a screw hole defined by the bottom rim lid.

4. The aquatic specimen capture device of claim 1, wherein the top rim lid is attached to the top end of the collapsible elongated container using a plurality of mount clips and a plurality of top snare clips.

5. The aquatic specimen capture device of claim 1, wherein a clasp is constructed and arranged to be placed inside the top end of the collapsible elongated container.

6. The aquatic specimen capture device of claim 1, wherein the plurality of the living hinges are mechanically attached to the plurality of the corner sides of the collapsible elongated container.

7. The aquatic specimen capture device of claim 1, wherein a fastener attached to the bottom rim lid comprises at least one of a zip tie lock, an elastic lock, a side extension lock, a clip lock, a pilot lock, or latch.

8. The aquatic specimen capture device of claim 1, wherein the collapsible elongated container forms a hollow body to receive and hold an aquatic species.

9. The aquatic specimen capture device of claim 1, wherein the collapse elongated container is a four-piece square shape.

10. The aquatic specimen capture device of claim 1, further comprising a plurality of corner sides are designed to maintain a safe distance from an aquatic species.

11. The aquatic specimen capture device of claim 1, further comprising a screen replaceably connected to the bottom rim lid thereby covering the bottom rim lid is designed to drain without unintended contact with the aquatic species.

12. A product, comprising:
a collapsible container comprising a top end opposite a bottom end, a plurality of corner sides disposed between the top end and bottom end to define a primary cavity therein;
a top rim lid comprising a handle, the top rim lid being removably attached to the top end of the collapsible container; and
a bottom rim lid removably attached to the bottom end of the collapsible container.

13. The product of claim 12, further comprising:
a plurality of mount clips attached to the top rim lid;
a plurality of top spear clips attached to the top rim lid; and
a clasp removably received in the top rim lid using a clasp flex lock and at least one clasp hinge.

14. The product of claim 12, further comprising:
a channel attached to the bottom rim lid designed to receive the collapsible container;
a fastener attached to the bottom rim lid designed to removably attach a second collapsible container to the collapsible container;
a screen removably connected to the bottom rim lid constructed and arranged to cover the bottom rim lid;
a plurality of bottom snare clips mechanically attached to the bottom rim lid; and
a screw hole defined by the bottom rim lid.

15. The product of claim 12, wherein the top rim lid is attached to the top end of the collapsible elongated container using a plurality of mount clips and a plurality of top snare clips.

16. The product of claim 12, wherein a clasp is constructed and arranged to be placed inside the top end of the collapsible elongated container.

17. The product of claim 12, wherein the plurality of the living hinges are mechanically attached to the plurality of the corner sides of the collapsible elongated container.

18. The product of claim 12, wherein the collapsible container, top rim lid, and bottom rim lid comprise at least one of a polyolefin, polyethylene, polypropylene, polyvinyl chloride, or fluoropolymer.

19. The product of claim 12, wherein the collapsible container, top rim lid, and bottom rim lid comprise a corrosion-resistant material.

20. A corrosion-resistant product, comprising:
a collapsible container comprising a top end opposite a bottom end, a plurality of corner sides disposed between the top end and bottom end to define a primary cavity therein;
a top rim lid comprising a handle, the top rim lid being removably attached to the top end of the collapsible container via a plurality of mount clips;
a bottom rim lid removably attached to the bottom end of the collapsible container, the bottom rim lid defining at least one screw hole therein; and
a screen replaceably connected to the bottom rim lid, thereby covering the bottom rim lid.
